(19) United States
(12) Patent Application Publication
(10) Pub. No.: US 2015/0145190 A1
(43) Pub. Date: May 28, 2015

(54) LIQUID SEALED-IN VIBRATION DAMPER

(71) Applicants: TOYOTA JIDOSHA KABUSHIKI KAISHA, Toyota-shi (JP); Sumitomo Riko Company Limited, Komaki-shi (JP)

(72) Inventors: Tomoyuki KISHIDA, Nisshin-shi (JP); Shoji OGIMURA, Toyota-shi (JP); Hideyuki KOMITSU, Toyota-shi (JP); Michiharu HIKOSAKA, Komaki-shi (JP); Takayuki GOTO, Kasugai-shi (JP)

(73) Assignees: Sumitomo Riko Company Limited, Komaki-shi (JP); TOYOTA JIDOSHA KABUSHIKI KAISHA, Toyota-shi (JP)

(21) Appl. No.: 14/550,460

(22) Filed: Nov. 21, 2014

(30) Foreign Application Priority Data
Nov. 28, 2013 (JP) 2013-246588

(51) Int. Cl. F16F 13/14

(52) U.S. Cl. CPC F16F 13/14
USPC 267/140.11

(57) ABSTRACT

A liquid sealed-in vibration damper respectively connected with two members that perform a relative displacement includes an elastic member, which is provided therein with a liquid chamber in which a liquid is sealed. When a direction from a side of the liquid sealed-in vibration damper connected with one of the two members to a side of the liquid sealed-in vibration damper connected with the other of the two members is set to an extension direction of the elastic member, a recess is provided in a region between an end portion on a side of the elastic member connected with any one of the two members and the liquid chamber, the recess being recessed in a direction orthogonal to the extension direction up to a position where a position of the recess in the orthogonal direction is located at an inner side of the liquid chamber.

### INCORPORATION BY REFERENCE

The disclosure of Japanese Patent Application No. 2013-246588 filed on Nov. 28, 2013 including the specification, drawings and abstract is incorporated herein by reference in its entirety.

### BACKGROUND OF THE INVENTION

1. Field of the Invention

The invention relates to a liquid sealed-in vibration damper having an elastic member that is provided therein with a liquid chamber in which a liquid is sealed.

2. Description of Related Art

As a liquid sealed-in vibration damper, a device disclosed in Japanese Patent Application Publication No. 2004-211807 (JP 2004-211807 A) has been known. The liquid sealed-in vibration damper used as a transmission mount of a vehicle that is described in this document has a metallic outer cylinder member connected with the transmission, a metallic inner cylinder member connected with a vehicle body, a rubber elastic member sandwiched therebetween, and a liquid chamber formed in the elastic member. Such a vibration damper achieves a vibration damping effect on the vibration inputted from the outside by an inhibition action of vibration transmission produced by the elastic deformation of the elastic member and an effect of attenuation of vibration produced by the flow of the liquid sealed in the liquid chamber.

However, in the case where such a liquid sealed-in vibration damper is used as a vibration damper of a suspending and supporting portion of a comparatively light member such as an exhaust pipe, if the spring constant of the elastic member is not sufficiently reduced, the vibration transmission rate from the exhaust pipe to the vehicle body floor will become large, and a sufficient vibration damping effect will not be obtained. However, in order to ensure a durability relative to a damage and the like, a partition wall portion of the liquid chamber in the elastic member needs to have a certain thickness, and there is a limit in the reduction of the spring constant of the elastic member.

### SUMMARY OF THE INVENTION

The invention provides a liquid sealed-in vibration damper that can reduce a spring constant of an elastic member to thereby reduce a vibration transmission rate.

A first aspect of the invention relates to a liquid sealed-in vibration damper respectively connected with two members that perform a relative displacement.

The liquid sealed-in vibration damper has an elastic member that is provided therein with a liquid chamber in which a liquid is sealed. When a direction from a side of the liquid sealed-in vibration damper connected with one of the two members to a side of the liquid sealed-in vibration damper connected with the other of the two members is set to an extension direction of the elastic member, a recess is provided in a region between an end portion on a side of the elastic member connected with any one of the two members and the liquid chamber, the recess being recessed in a direction orthogonal to the extension direction up to a position where a position of the recess in the orthogonal direction is located at the inner side of the liquid chamber.

In such a liquid sealed-in vibration damper, when a vibration load in the above extension direction is inputted, a part of the recess on the liquid chamber side in the elastic member undergoes shearing. Thus, the spring constant of the elastic member in the above extension direction becomes small. Thus, the spring constant of the elastic member can be reduced to thereby reduce the vibration transmission rate.

Such a liquid sealed-in vibration damper can be formed into, for example, a torus shape, with an inner circumference and an outer circumference of which the two members are connected, respectively. In this case, as long as a recess is provided in a part of the elastic member closer to the inner circumference side than the liquid chamber, the volume of the liquid chamber is easily ensured.

In addition, in the case where such a liquid sealed-in vibration damper is sandwiched between a vehicle body floor and an exhaust pipe, the liquid sealed-in vibration damper is provided at a position closest to an end side of the exhaust pipe among a plurality of positions, at which the exhaust pipe is suspended, provided at the vehicle body floor, thereby the vibration of the exhaust pipe relative to the vehicle body floor can be inhibited more efficiently.

### BRIEF DESCRIPTION OF THE DRAWINGS

Features, advantages, and technical and industrial significances of embodiments of the invention will be described below with reference to the accompanying drawings, in which like numerals denote like elements, and wherein:

FIG. 1 is a perspective view of an embodiment of the liquid sealed-in vibration damper;

FIG. 2 is a sectional view of the liquid sealed-in vibration damper in FIG. 1;

FIG. 3 is a view schematically showing an example of the manner of suspending the exhaust pipe from the vehicle body floor using the liquid sealed-in vibration damper in FIG. 1;

FIG. 4 is a top view obtained by observing the liquid sealed-in vibration damper in FIG. 1 and its surrounding part from the front side;

FIG. 5 is a sectional view obtained by observing the liquid sealed-in vibration damper in FIG. 1 and its surrounding part from the lateral side;

FIG. 6 is a view showing the acting manner of the force during the input of the vibration in a comparative example of the liquid sealed-in vibration damper without a recess;

FIG. 7 is a view showing the acting manner of the force during the input of the vibration in the liquid sealed-in vibration damper in FIG. 1;

FIG. 8 is a sectional view of a modification example of the liquid sealed-in vibration damper, in which recesses are provided on the outer circumference side of the liquid chamber; and

FIG. 9 is a sectional view of a modification example of the liquid sealed-in vibration damper in which a recess is only provided on a single side.

### DETAILED DESCRIPTION OF EMBODIMENTS

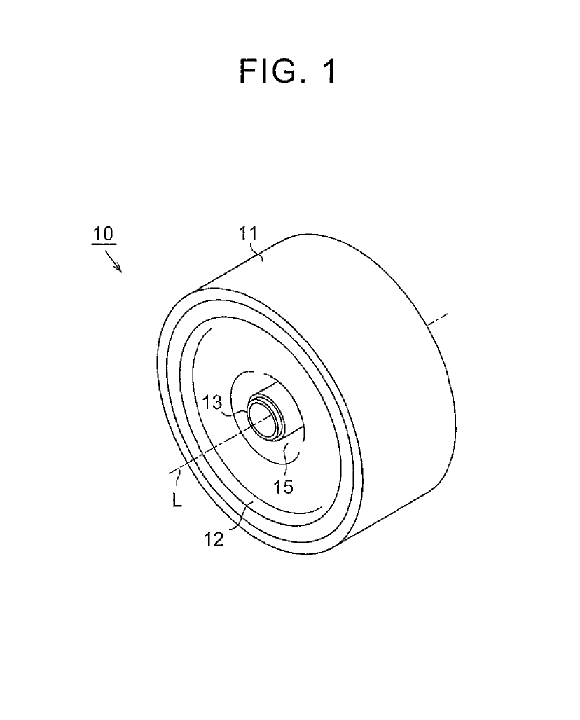

An embodiment of the liquid sealed-in vibration damper is described in detailed below with reference to FIGS. 1-7. In addition, the liquid sealed-in vibration damper in this embodiment is sandwiched between a vehicle body floor and an exhaust pipe suspended from the vehicle body floor. That is, in this embodiment, the vehicle body floor and the exhaust pipe correspond to the two members, one being suspended from the other.

As shown in FIG. 1, the liquid sealed-in vibration damper 10 in this embodiment has a metallic outer cylinder member 11 formed into a round pipe shape. A rubber elastic member 12 formed into a substantial torus shape is pressed in the inner circumference of the outer cylinder member 11, and further an inner cylinder member 13 formed into a round pipe shape is pressed in the inner circumference of the elastic member 12.

In addition, in this liquid sealed-in vibration damper 10, the outer cylinder member 11 is connected with the vehicle body floor, and the inner cylinder member 13 is connected with the exhaust pipe. Thus, in this embodiment, the radial direction of the liquid sealed-in vibration damper 10 becomes a direction from a side of the liquid sealed-in vibration damper 10 connected with one of the above two members (the vehicle body floor and the exhaust pipe) to a side of the liquid sealed-in vibration damper 10 connected with the other of the above two members, i.e., an extension direction of the elastic member 12. Moreover, a direction along a central axis L of the liquid sealed-in vibration damper 10 formed into a torus shape as a whole (hereinafter referred to as the axial direction) becomes a direction orthogonal to such an extension direction of the elastic member 12.

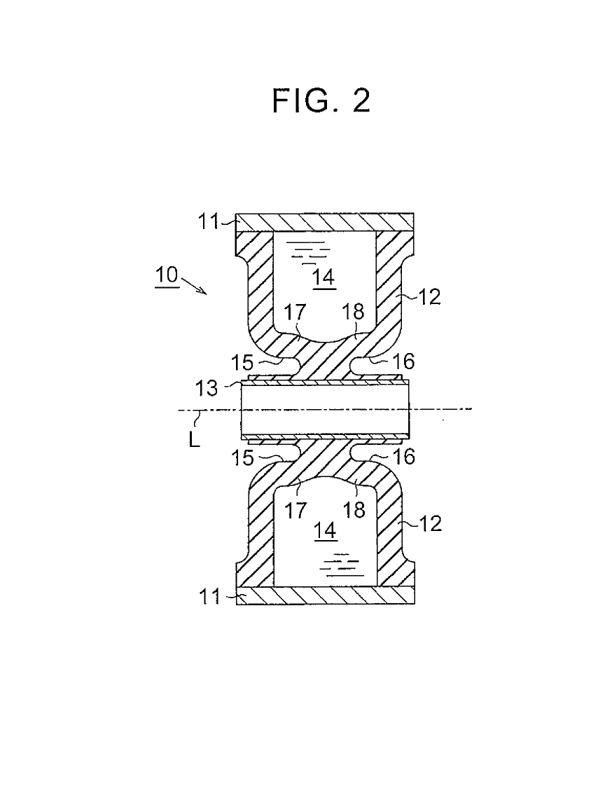

FIG. 2 shows a cross section structure of the liquid sealed-in vibration damper 10. In addition, hereinafter, the left side in the figure is set to the front of the liquid sealed-in vibration damper 10, and the right side in the figure is set to the rear of the liquid sealed-in vibration damper 10. As shown in this figure, the outer circumference of the elastic member 12 is provided with a part which is recessed all over the whole circumference thereof towards the inner circumference side, and the outer circumference side of the elastic member 12 is blocked using the outer cylinder member 11, thereby forming a liquid chamber 14. An incompressible liquid is sealed in the inside of the liquid chamber 14.

In addition, in the front and rear end surfaces of the elastic member 12, recesses 15 and 16 that are recessed in the axial direction are respectively provided in parts on the inner circumference side of the liquid chamber 14. These recesses 15 and 16 are formed by being recessed up to positions in which positions of the recesses in the axial direction are located at the inner side of the liquid chamber 14. By providing such recesses 15 and 16, arms 17 and 18 extending in the axial direction are formed on the inner circumference side of the liquid chamber 14 of the elastic member 12.

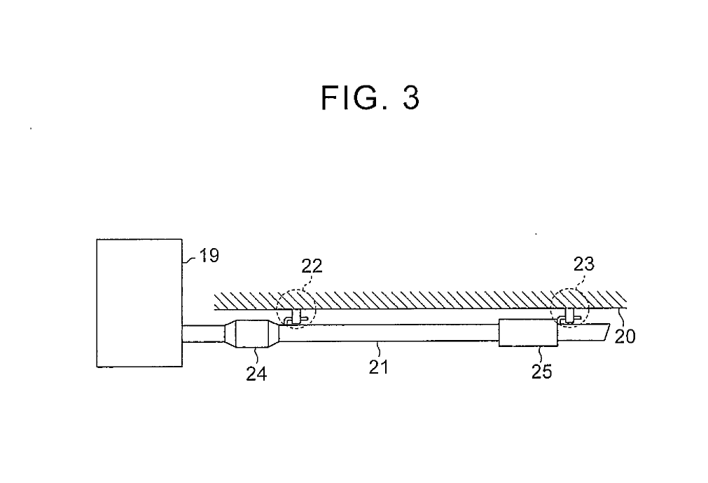

FIG. 3 shows an example of the manner of suspending the exhaust pipe from the vehicle body floor using such a liquid sealed-in vibration damper 10. As shown in this figure, in an exhaust pipe 21 provided to extend from an engine 19 toward the rear of the vehicle body, a catalyst 24 is provided at a part of the exhaust pipe 21 on the side of the engine 19, and a muffler 25 is provided at a part near the pipe end of the exhaust pipe 21. The vehicle body floor 20 is provided with a plurality of (two in the example in this figure) suspension positions 22 and 23 of such an exhaust pipe 21. Incidentally, in the example in this figure, the suspension position 22 is provided at a position on the pipe end side of the exhaust pipe 21 where the catalyst 24 is provided, and the suspension position 23 is provided in a position on the exhaust pipe 21 where the muffler 25 is provided. Moreover, the liquid sealed-in vibration damper 10 in this embodiment is provided at the suspension position 23 closest to the rear end side of the exhaust pipe among these suspension positions 22 and 23.

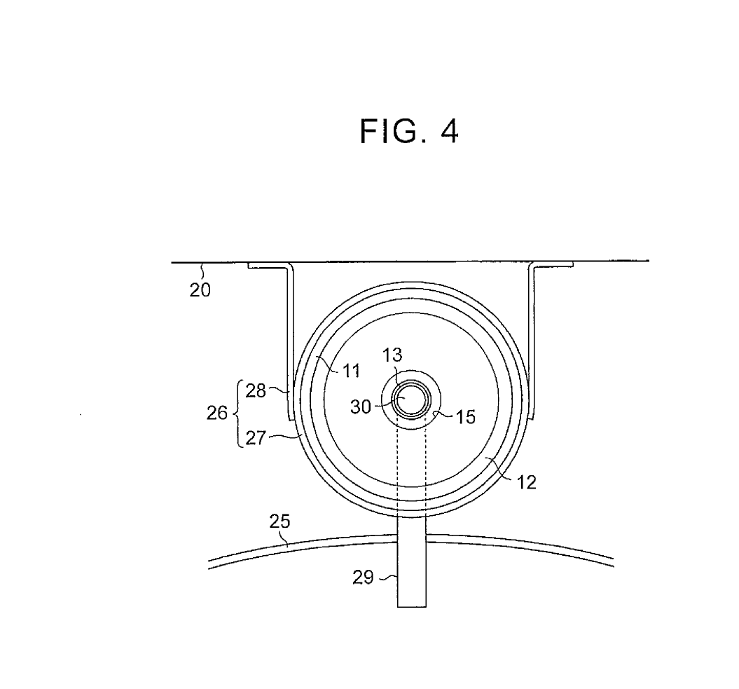

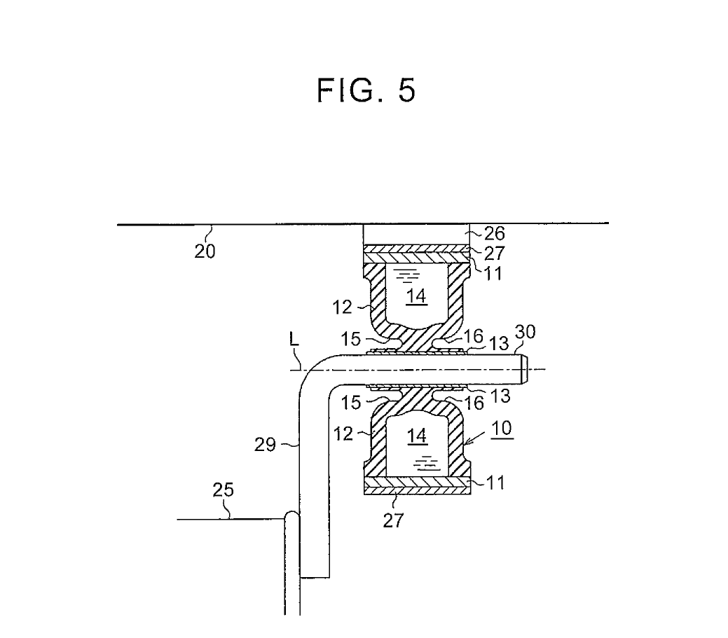

FIG. 4 and FIG. 5 show an example of the manner of connecting the liquid sealed-in vibration damper 10 to the vehicle body floor. 20 and the exhaust pipe 21. As shown in this figure, the connection of the liquid sealed-in vibration damper 10 to the vehicle body floor 20 is performed via a floor installation member 26. The floor installation member 26 has a metallic round pipe portion 27 formed into a round pipe shape and two fixation portions 28, which are fixed to both sides of the round pipe portion 27, respectively, and are formed by sheet metals bent into an L shape. Moreover, the round pipe portion 27 is externally embedded in the outer circumference of the outer cylinder member 11, and the fixation portions 28 are fixed to the vehicle body floor 20 using joints based on welding, bolts, screws and the like, thereby the liquid sealed-in vibration damper 10 is connected with the vehicle body floor 20.

In addition, the connection of the liquid sealed-in vibration damper 10 to the exhaust pipe 21 is performed via an exhaust pipe installation member 29. The exhaust pipe installation member 29 fixed on the muffler 25 of the exhaust pipe 21 is provided with an installation shaft 30 having a round rod shape that extends along the extension direction of the exhaust pipe 21. Moreover, the liquid sealed-in vibration damper 10 is connected with the exhaust pipe 21 by inserting the installation shaft 30 into the inner circumference of the inner cylinder member 13. In addition, the installation shaft 30 is inserted to be slidable along the axial direction relative to the inner cylinder member 13. Thus, the displacement of the exhaust pipe installation member 29 caused by the thermal expansion of the exhaust pipe 21 can be absorbed by the sliding of the installation shaft 30 relative to the inner cylinder member 13.

Next, the function of the liquid sealed-in vibration damper 10 formed in the way as mentioned above is described. In the liquid sealed-in vibration damper 10 in this embodiment, when the exhaust pipe 21 vibrates relative to the vehicle body floor 20, the elastic member 12 is elastically deformed by being compressed or elongated in the radial direction, so that the vibration transmission between the vehicle body floor 20 and the exhaust pipe 21 is inhibited. In addition, the liquid chamber 14 is deformed by the elastic deformation of the elastic member 12 at this time, and by this deformation, the liquid sealed in the liquid chamber 14 flows from the part where the cross section is narrowed to the part where the cross section is broadened, thereby producing an effect of attenuation of vibration.

On the other hand, in order to inhibit the transmission of the vibration from the exhaust pipe 21 to the vehicle body floor 20, it is required to sufficiently reduce a spring constant of the elastic member 12 of the liquid sealed-in vibration damper 10 to make the load transmitted to the vehicle body floor 20 become small relative to a vibration displacement of the exhaust pipe 21. In this regard, in the liquid sealed-in vibration damper 10 in this embodiment, as mentioned above, the recesses 15 and 16 that are recessed in the axial direction are provided in the parts on the inner circumference side of the liquid chamber 14 in the elastic member 12. Moreover, as mentioned below, such recesses 15 and 16 comparatively greatly contribute to the reduction of the spring constant of the elastic member 12 in the above extension direction.

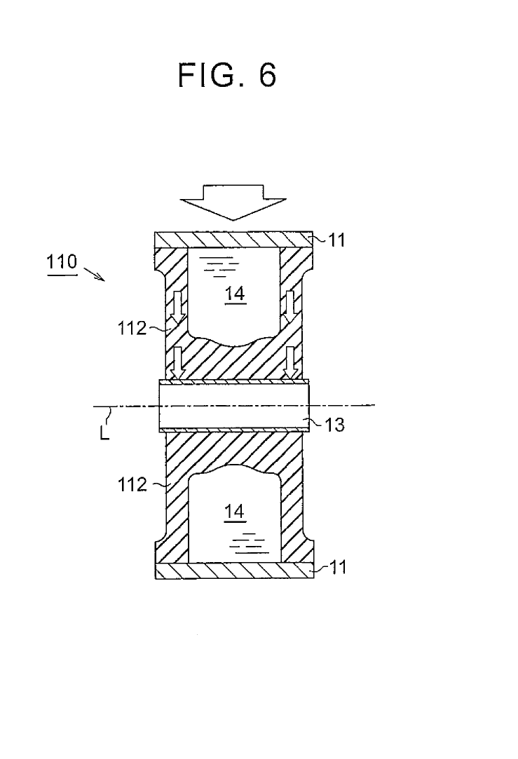

FIG. 6 shows a cross section structure of a liquid sealed-in vibration damper 110 having an elastic member 112 in which the recesses 15 and 16 are not provided as a comparative example. In this comparative example, the load inputted to the liquid sealed-in vibration damper 110 is directly transmitted to the inner circumference of the elastic member 12 through the parts on both sides of the liquid chamber 14. Thus, in this comparative example, the elastic deformation of the elastic member 112 at this time is performed in a compression-elongation mode.

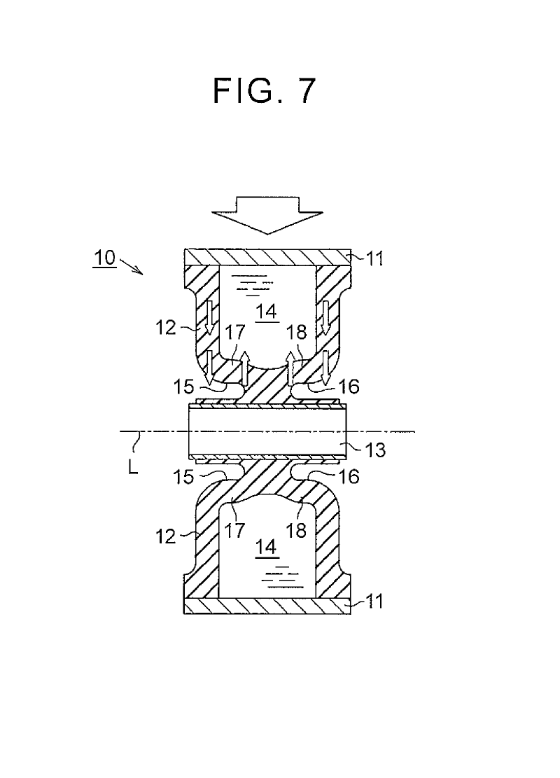

FIG. 7 shows a state in which the load is inputted to the liquid sealed-in vibration damper 10 from the outer circumference of the liquid sealed-in vibration damper 10 in this embodiment. In the liquid sealed-in vibration damper 10 in this embodiment, the recesses 15 and 16 are provided on the extension lines of the parts on both sides of the liquid chamber 14 in the radial direction, respectively, so a shearing stress is applied to the arms 17 and 18 extending in the axial direction that are formed on the outer circumference side of the recesses 15 and 16. Thus, the arms 17 and 18 of the elastic member 12 at this time are elastically deformed in a shearing mode, and the spring constant of the elastic member 12 relative to the input of the load in the radial direction is smaller than that in the comparative example.

The liquid sealed-in vibration damper 10 according to this embodiment as described above can achieve the following effects:

(1) In the liquid sealed-in vibration damper 10 in this embodiment, recesses 15, 16 are formed in a region between an end portion on a side of the elastic member 12 connected with the exhaust pipe 21 (the inner circumference of the elastic member 12) and the liquid chamber 14, the recesses being recessed in the axial direction up to a position where a position of the recess in this axial direction is located at the inner side of the liquid chamber 14. Thus, relative to the input of the vibration from the exhaust pipe 21, an elastic deformation in a shearing mode is produced at the elastic member 12. Thus, the spring constant of the elastic member 12 can be reduced to thereby reduce the vibration transmission rate from the exhaust pipe 21 to the vehicle body floor 20.

(2) Even if the thickness of the partition wall portion of the liquid chamber 14 in the elastic member 12 is not made to become small, the spring constant can be reduced, so a durability relative to an external damage and the like is easily ensured.

(3) The recesses 15 and 16 are provided on the inner circumference side of the liquid chamber 14 in the elastic member 12 formed into a torus shape, so the volume of the liquid chamber 14 is easily ensured.

(4) The liquid sealed-in vibration damper 10 is provided at the suspension position 23 at which the vibration amplitude of the exhaust pipe 21 is the maximum, i.e., closest to the end side of the exhaust pipe, among a plurality of suspension positions 22 and 23 of the exhaust pipe 21 which are provided at the vehicle body floor 20, so the vibration of the exhaust pipe 21 can be effectively inhibited.

In addition, the above embodiment can also be changed as below to be carried out.

In the above embodiment, the outer cylinder member 11 and the inner cylinder member 13 are made of metal, but they can also be formed using other materials.

In the above embodiment, the elastic member 12 is made of rubber, but the elastic member 12 can also be formed using other elastic materials than the rubber.

In the above embodiment, the outer circumference and the inner circumference of the elastic member 12 are provided with the metallic outer cylinder member 11 and inner cylinder member 13, but one or both of them can be omitted, and the elastic member 12 can be directly installed on one or both of the floor installation member 26 and the exhaust pipe installation member 29.

In the above embodiment, the liquid sealed-in vibration damper 10 is respectively connected with the vehicle body floor 20 and the exhaust pipe 21 via the floor installation member 26 and the exhaust pipe installation member 29, but the liquid sealed-in vibration damper 10 can also be connected in other manners than the above manner.

The number of the suspension positions of the exhaust pipe 21 provided at the vehicle body floor 20 can be arbitrarily changed. In addition, the liquid sealed-in vibration damper 10 can also be provided at a suspension position other than the suspension position closest to the end side of the exhaust pipe. Moreover, the liquid sealed-in vibration damper 10 can also be respectively provided at a plurality of suspension positions.

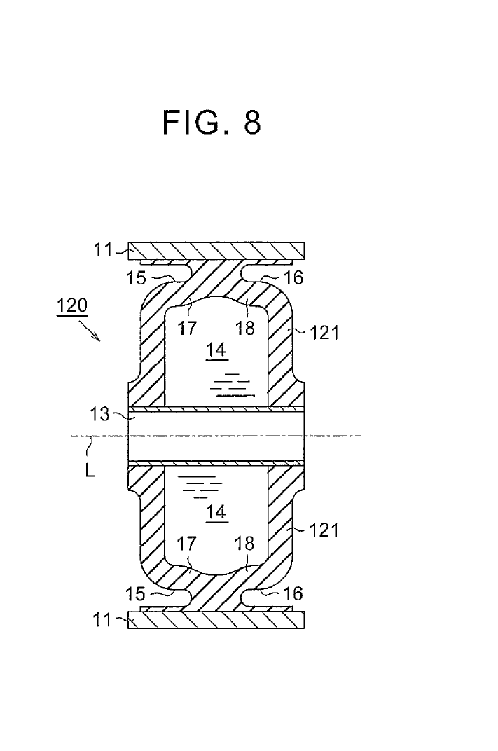

The recesses 15 and 16 can also be provided in the parts on the outer circumference side of the liquid chamber 14 in an elastic member 121 as those in a liquid sealed-in vibration damper 120 illustrated in FIG. 8. In this case, similar to the above embodiment, the spring constant of the elastic member 12 can also be reduced to thereby properly reduce the vibration transmission rate.

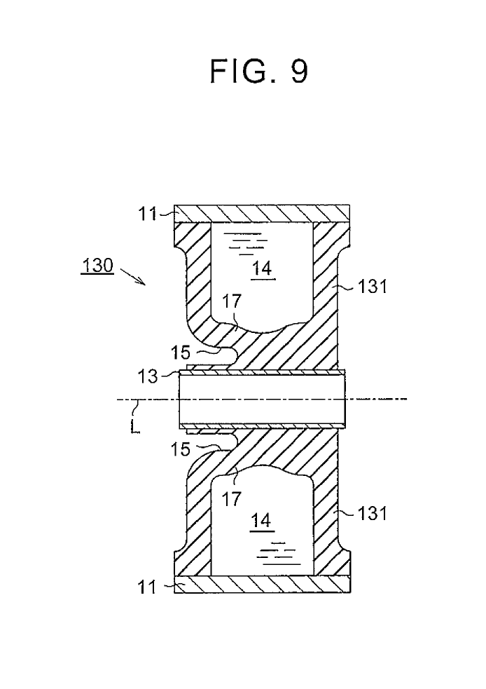

The recess 15 can also be only provided on any one of a front side and a rear side of an elastic member 131 as that in a liquid sealed-in vibration damper 130 illustrated in FIG. 9. In the case where the exhaust pipe 21 vibrates in a direction swinging relative to the central axis, the vibration load intensively acts on one of the parts on both sides of the liquid chamber 14 in the elastic member 131. In this case, even if no recess is provided on a side on which the vibration load intensively acts, a proper vibration inhibition can be performed.

The liquid sealed-in vibration damper 10 in the above embodiment is used at the suspension position of the exhaust pipe 21 relative to the vehicle body floor 20, but the liquid sealed-in vibration damper having the same structure can also be adopted for other uses than the above use.

The liquid sealed-in vibration damper 10 in the above embodiment is formed into a torus shape, but the liquid sealed-in vibration damper can also be formed into other shapes than the above shape. In this case, as long as a recess is provided in a region between one of both ends of the elastic member in the extension direction and the liquid chamber, the recess being recessed in a direction orthogonal to the extension direction up to a position where a position of the recess in the orthogonal direction is located at the inner side of the liquid chamber, the spring constant of the elastic member can be reduced to thereby reduce the vibration transmission rate.

The liquid chambers can also be formed into a structure in which in a member one liquid chamber is provided on the inner side while one liquid chamber is provided on the outer side and a recess is provided between the inner liquid chamber and the outer liquid chamber.

What is claimed is:

1. A liquid sealed-in vibration damper, which is respectively connected with two members that perform a relative displacement, comprising an elastic member, which is provided therein with a liquid chamber in which a liquid is sealed,
wherein when a direction from a side of the liquid sealed-in vibration damper connected with one of the two members to a side of the liquid sealed-in vibration damper connected with the other of the two members is set to an extension direction of the elastic member, a recess is provided in a region between an end portion on a side of the elastic member connected with any one of the two members and the liquid chamber, the recess being recessed in a direction orthogonal to the extension direction up to a position where a position of the recess in the orthogonal direction is located at an inner side of the liquid chamber.

2. The liquid sealed-in vibration damper according to claim 1, wherein
the liquid sealed-in vibration damper is formed into a torus shape, with an inner circumference and an outer circumference of which the two members are connected, respectively.

3. The liquid sealed-in vibration damper according to claim 2, wherein
the recess is provided in a part of the elastic member closer to an inner circumference side than the liquid chamber.

4. The liquid sealed-in vibration damper according to claim 1, wherein
the liquid sealed-in vibration damper is sandwiched between a vehicle body floor and an exhaust pipe, and is provided at a position closest to a rear end side of the exhaust pipe among a plurality of positions, at which the exhaust pipe is suspended, provided at the vehicle body floor.
